(19) United States
(12) Patent Application Publication
(10) Pub. No.: US 2026/0219040 A1
(43) Pub. Date: Jul. 30, 2026

(54) Laser Level

(71) Applicant: Milwaukee Electric Tool Corporation, Brookfield, WI (US)

(72) Inventor: David W. Draeger, Sussex, WI (US)

(21) Appl. No.: 19/421,615

(22) Filed: Dec. 16, 2025

Related U.S. Application Data
(60) Provisional application No. 63/749,911, filed on Jan. 27, 2025.

(51) Int. Cl. G01C 9/06

(52) U.S. Cl. CPC G01C 9/06; G01C 2009/066

(57) ABSTRACT

Various laser level designs are shown. In one example, the laser level is a multi-plane laser level that emits plane(s) out of a plurality of cage(s). Each cage is formed from a material having a thickness less than a maximum thickness to reduce a portion of the laser plane blocked by the cage. In various embodiments, the cage includes a plurality of windows positioned between an upper polymer portion and a lower polymer portion. In various specific embodiments, the upper polymer portion and lower polymer portion are formed from a rigid polymer.

### CROSS-REFERENCE TO RELATED PATENT APPLICATION

The present application claims the benefit of and priority to U.S. Provisional Application No. 63/749,911, filed Jan. 27, 2025, which is incorporated herein by reference in its entirety.

### BACKGROUND OF THE INVENTION

The present invention relates generally to the field of tools. The present invention relates specifically to a laser level, such as a 3-plane laser level that projects one or more laser lines onto a work piece or work surface. The laser level includes strong protective cage(s) that reduce the amount of blocked emitted light from the laser level.

### SUMMARY OF THE INVENTION

One embodiment of the invention relates to a laser level including a housing and a laser generator positioned within the housing. The laser generator is configured to emit a laser projection plane. The laser level includes a cage rigidly coupled to the housing. The cage includes a frame with a lower portion, an aperture in the lower portion of the frame, a top portion, and a plurality of legs each extending between the lower portion and the top portion. The plurality of legs together define a plurality of windows. The laser level further includes an upper bumper positioned on the top of the frame and a lower mounting element positioned on the lower portion of the frame. The plurality of windows are positioned between the upper bumper and the lower mounting element. The frame is formed from a first material and the upper bumper is formed from a second material. The second material is different than the first material. The laser generator is configured to direct a laser projection out of the plurality of windows.

In specific embodiments, the first material is more rigid than the second material. In specific embodiments, the first material is metal and the second material is a polymer. In specific embodiments, the frame is formed from steel and the second material is nylon. In such embodiments, the frame is overmolded with a polymer that forms the upper bumper and the mounting flange. In such embodiments, the upper bumper and the mounting flange form a seal with the plurality of windows.

Another embodiment of the invention relates to a laser level including a housing and a laser generator positioned within the housing. The laser generator is configured to emit a laser projection plane. The laser level includes a cage fixedly coupled to the housing. The cage includes a frame with a base comprising an aperture and a first portion coupled to the base. The first potion includes a first leg, a second leg, and a first body connecting the first leg and the second leg. The frame has a second portion coupled to the base. The second portion has a third leg, a fourth leg, and a second body connecting the third leg and the fourth leg. The second body is connected to the first body. The first leg, second leg, third leg, and fourth leg together define a plurality of windows. The laser level further includes an upper bumper positioned on a top of the frame and a lower mounting element positioned on the base of the frame. The lower mounting element is positioned between the plurality of windows and the base of the frame. The laser generator is configured to direct a laser projection out of the plurality of windows.

Another embodiment of the invention relates to a laser level including a housing and a laser generator positioned within the housing. The laser generator is configured to emit a plurality of laser projection planes. The laser level includes a first cage rigidly coupled to the housing. The first cage includes a frame with a base comprising an aperture and a first portion with a first leg, a second leg, the first leg and the second leg coupled to the base. The frame includes a second portion having a third leg and a fourth leg. The third leg and the fourth leg are connected to the base. The first leg, the second leg, third leg, and fourth leg together define a plurality of windows. The laser level includes an upper bumper positioned on the frame and a lower mounting element positioned between the plurality of windows and the base of the frame. The laser generator is configured to direct one of the plurality of laser projection planes out of the plurality of windows of the first cage.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a laser level emitting laser planes, according to an exemplary embodiment.

FIG. 2 is a top view of the laser level of FIG. 1, according to an exemplary embodiment.

FIG. 3 is a left side view of the laser level of FIG. 1, according to an exemplary embodiment.

FIG. 4 is a right side view of the laser level of FIG. 1, according to an exemplary embodiment.

FIG. 5 is a front view of the laser level of FIG. 1 with cage windows removed, according to an exemplary embodiment.

FIG. 6 is a perspective view of the laser level of FIG. 1 with the housing removed, according to an exemplary embodiment.

FIG. 7 is a detailed perspective view of a cage of the laser level of FIG. 1, according to an exemplary embodiment.

FIG. 8 is a detailed perspective view of the cage with the windows removed, according to an exemplary embodiment.

FIG. 9 is a detailed perspective view from above of the cage of the laser level of FIG. 1 with the windows removed, according to an exemplary embodiment.

FIG. 10 is a perspective view from below of the cage with the windows removed, according to an exemplary embodiment.

FIG. 11 is a perspective view from below of a partial exploded view of the cage, according to an exemplary embodiment.

FIG. 12 is a perspective view of a partial exploded view of the cage, according to an exemplary embodiment.

FIG. 13 is a perspective view of a partial exploded view of the cage, according to an exemplary embodiment.

FIG. 14 is an exploded view of the cage, according to an exemplary embodiment.

FIG. 15 is a perspective view of a frame of the cage, according to an exemplary embodiment.

FIG. 16 is an exploded view of the frame of the cage, according to an exemplary embodiment.

### DETAILED DESCRIPTION

Referring generally to the figures, various embodiments of laser projection devices, are shown. As discussed herein, Applicant has developed a number of improvements to a cage, such as a protective cage, for a laser level. In various specific embodiments, the improvements are made to cage(s) for a three plane laser level. As will be generally understood, to protect one or more component of a laser level system, the laser level includes a frame or cage surrounding windows through which the projected laser is transmitted. However, particularly in the context of a laser level that projects a line or plane, a laser discontinuity is formed because the structure of the cage blocks a portion of the laser and this discontinuity is then visible on the work piece or work surface.

In various embodiments, to improve the usability of such a laser despite the projection of this laser discontinuity, a frame of the laser level cage is formed from a material, such as steel in contrast to conventional protective cage frames that are typically formed from die-cast zinc or aluminum. Applicant believes forming the frame from steel improves strength of the cage and allows the legs and/or posts of the frame to have a reduced thickness which reduces the amount of obstruction of the laser projection (e.g., size of discontinuity).

In various embodiments, the cage further includes an upper polymer portion and a lower polymer portion positioned on opposing sides of the windows of the cage. In specific embodiments, the upper polymer portion and the lower polymer portion are overmolded onto the frame. Applicant believes using overmolding improves the sealing of the windows of the cage.

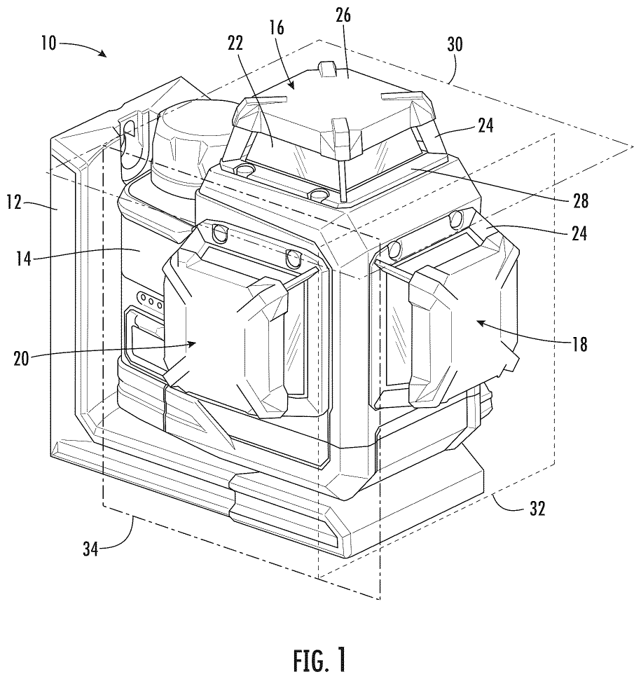

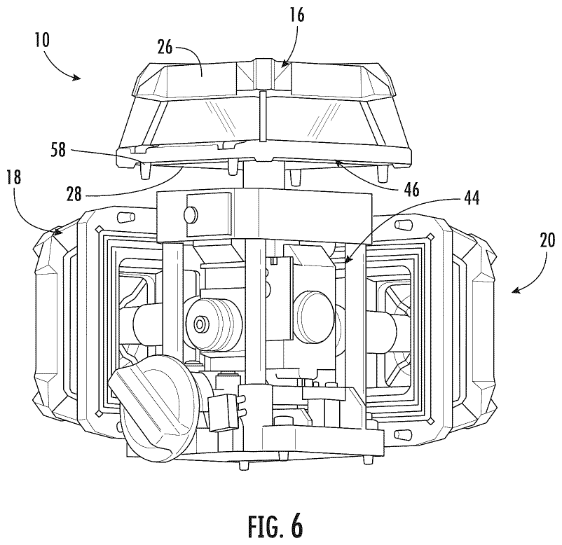

Referring to FIG. 1, various aspects of a laser beam generating device, shown as a laser level 10, are shown. In various specific embodiments, laser level 10 is a three plane laser level. Laser level 10 includes a housing 14 and a support, shown as a bracket 12. In various specific embodiments, bracket 12 is moveable to adjust a position of laser level 10 and/or housing 14. In various embodiments, a power supply, such as a battery, and a laser generator 44 (see e.g., FIG. 6) are positioned within housing 14. In general, laser generator 44 includes various components for generating the laser line or laser plane associated with laser level 10, including one or more laser emitting device (e.g. a laser diode etc.), various optical components (e.g., lens, collimators, mirrors, beam shapers, etc.) and supporting hardware (e.g. leveling pendulum, position sensors, electronic controllers, etc.).

In general, aperture 46 of cage 16 provides the space/area through which one or more component of laser generator 44 passes from housing 14 into a general space located within cage 16. In one specific embodiment in which laser level is a 360 degree planar laser, a cone mirror is located within cage 16 and a laser beam generated by a laser diode within housing 14 is directed through aperture 46 centered on a tip of the cone mirror to generate a projected laser plane 30.

In various embodiments, laser level 10 includes one or more protective cages, shown as cage 16, 18, 20. In specific embodiments, laser level 10 includes a first cage 16, a second cage 18, and a third cage 20. In such an embodiment, each cage 16, 18, 20 is fixed to housing 14. In such an embodiment, a first plane 30 is associated with first cage 16, a second plane 32 is associated with second cage 18, and a third plane 34 is associated with third cage 20. In other words, a plane 30, 32, 34 will be projected out of each cage 16, 18, 20.

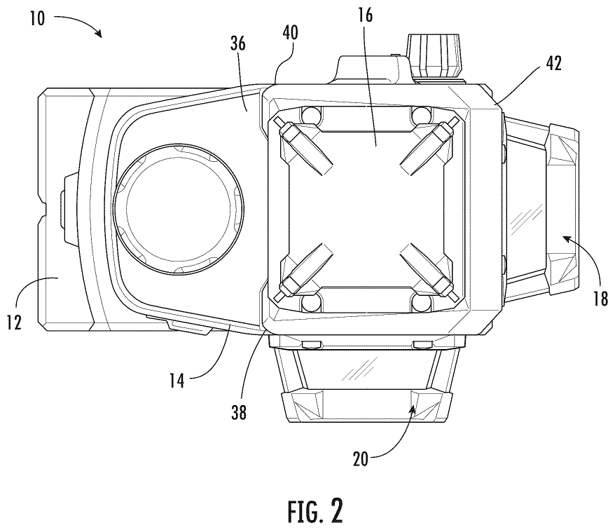

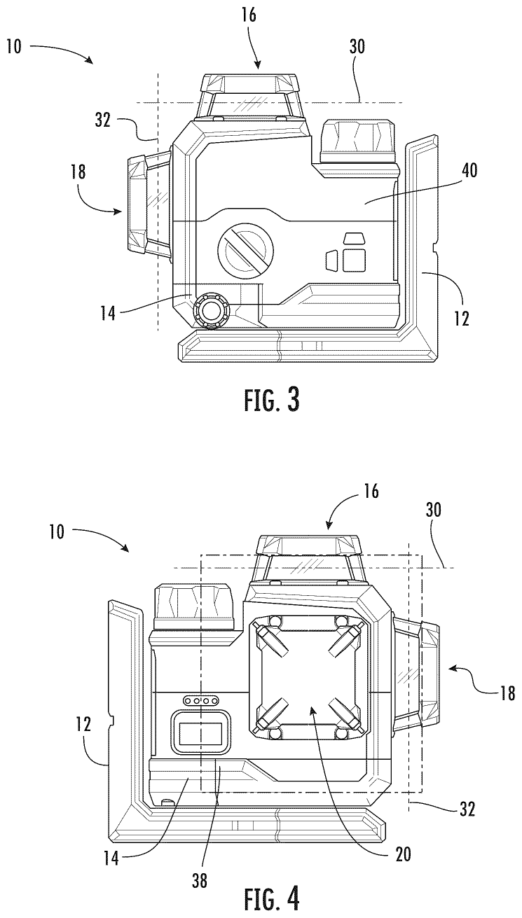

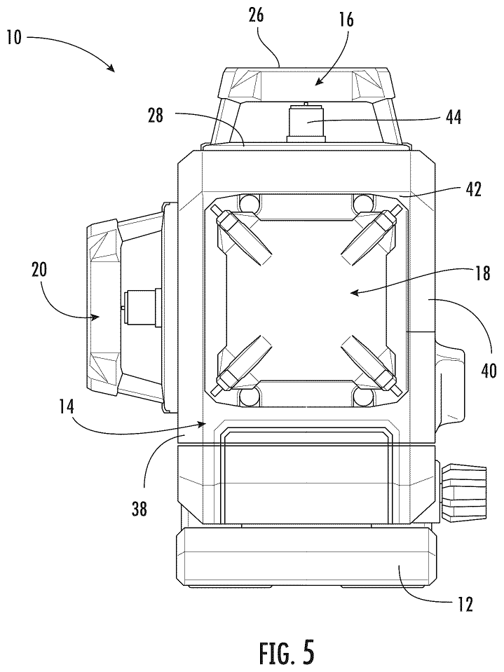

Referring to FIGS. 2-4, details of laser level 10 are shown according to an exemplary embodiment. In a specific embodiment, first plane 30 is a horizontal plane and second plane 32 and third plane 34 are each vertical planes (in the orientation shown in FIG. 1). In various specific embodiments, first cage 16 is positioned on an upward facing surface 36 of housing 14 (in the orientation shown in FIG. 2). Second cage 18 is positioned on a front or forward facing surface 42 of housing 14. Third cage 20 is positioned on a side surface, shown as right side surface 38 of housing 14. Housing 14 includes a second opposing side surface, shown as left side surface 40. In various embodiments, cages 16, 18, 20 are fixedly or rigidly coupled to housing 14. In other words, cages 16, 18, 20 are non-rotationally coupled to housing 14. In such embodiments, cages 16, 18, 20 are fixedly coupled to housing 14 via fasteners 58 (e.g., bolts, screws, etc.). It should be understood that the cages 16, 18, 20 could similarly be positioned on a different surface of the housing 14, projecting a vertical laser plane or a horizontal plane on the work surface.

Referring to FIG. 1, each cage 16, 18, 20 includes a frame 24, an upper portion and a lower portion that defines aperture 46. Frame 24 has a lower mounting element, shown as mounting flange 28, and a plurality of legs 50 to define a plurality of windows 22. Each leg 50 extends between the lower portion and top portion of frame 24. Upper bumper 26 is positioned on the top portion of frame 24. The lower mounting element or mounting flange 28 is positioned on the lower portion of frame 24.

Each window 22 is at least partially defined by the plurality of legs 50. In a specific embodiment, cage 16, 18, 20 includes four legs 50 and four windows 22. In specific embodiments, windows 22 are formed from glass. In another embodiment, cage 16, 18, 20 may include a different number of legs and windows (e.g., 8 legs and 8 windows, etc.). Each leg 50 blocks projection of a portion of the laser projection or plane (see e.g., 30, 32, 34), defining a laser discontinuity. The laser projection is projected though at least one of the plurality of windows.

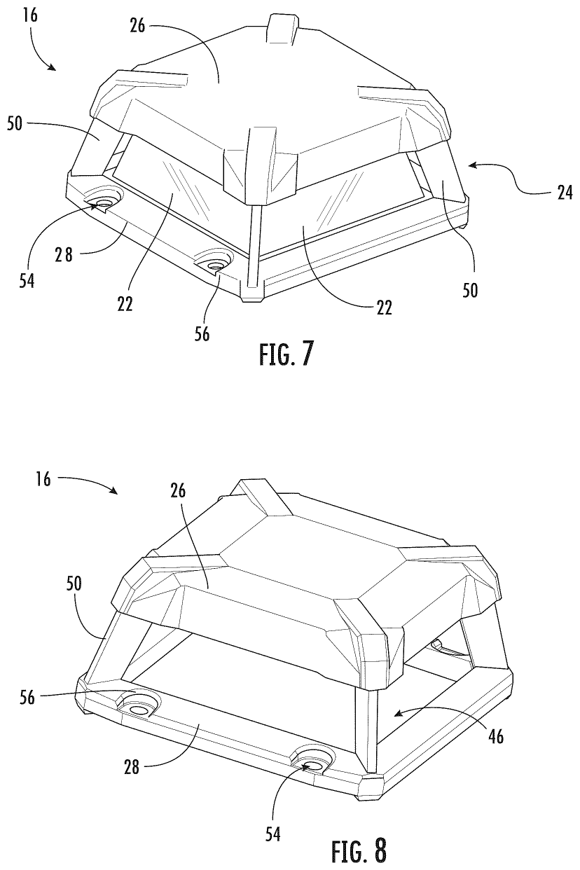

Referring to FIGS. 7-11, detailed perspective views of cage 16 are shown according to an exemplary embodiments. Cages 18, 20 are substantially the same as cage 16 except for the differences discussed herein. Frame 24 of cage 16 includes a base 52 coupled to the plurality of legs 50. Mounting flange 28 surrounds base 52 of frame 24 when cage 16 is assembled. Upper bumper 26 is positioned on a top of frame 24 such that windows 22 are positioned between upper bumper 26 and mounting flange 28. Similarly, the plurality of legs 50 extend between upper portion of frame 24 and mounting flange 28. In various embodiments, the top portion of frame 24 includes a polymer overmold defining an uppermost surface of cage 16. In such embodiments, the overmold acts as bumper. The polymer overmold extends outward past outer edges of legs 50.

In various embodiments, upper bumper 26 and mounting flange 28 are formed from a polymer. In specific embodiments, upper bumper 26 and mounting flange 28 are formed from a rigid polymer, such as nylon. In various specific embodiments, a thermoplastic elastomer (TPE) is used on top of the rigid polymer for additional protection and/or sealing. In various embodiments, upper bumper 26 is overmolded onto frame 24. In various embodiments, mounting flange 28 is overmolded onto frame 24. In specific embodiments, both upper bumper 26 and mounting flange 28 are overmolded onto frame 24. As previously discussed, Applicant believes overmolding improves the sealing between upper portion and/or mounting flange 28 and windows 22. in various specific embodiments, the upper bumper 26 and/or mounting flange 28 meet the IP5X and IP4X sealing standards.

In various embodiments, frame 24 is formed from a metal material. In various specific embodiments, frame 24 is formed from steel. In various specific embodiments, frame 24 is a stamped steel. In various embodiments, the frame 24 material has a yield strength greater than a minimum yield strength. In various embodiments, the frame 24 material has a yield strength higher than die cast materials.

In various specific embodiments, frame 24 is formed from a first material and upper bumper and lower mounting element 28 are formed from a second material. In various embodiments, the second material is different than the first material. In various specific embodiments, the first material is more rigid than the second material. In various embodiments, the first material is metal and the second material is a polymer. In various specific embodiments, the first material is steel and the second material is nylon.

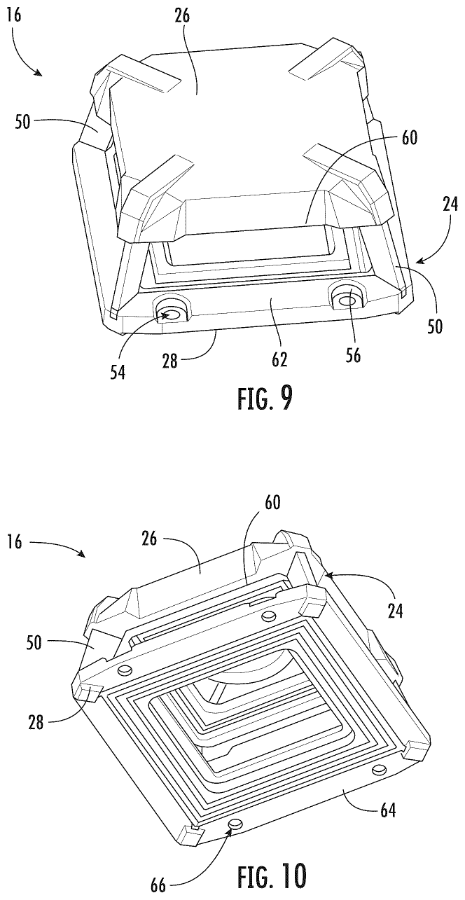

As shown in FIGS. 7-10, mounting flange 28 includes a recessed portion 56 having a bore or opening 66. Bore 66 is configured to receive fastener 58 to secure cage 16 to housing 14. Bore 66 extends through mounting flange 28 from a top or upward facing surface 62 (in orientation shown in FIG. 9) of mounting flange 28 to a bottom or downward facing surface 64 (in orientation shown in FIG. 10). Each window 22 is positioned between a lower edge 60 of upper bumper of frame 24 and upward facing surface 62 of mounting flange 28. In specific embodiments, lower edge 60 is the lowermost edge of upper bumper 26. Frame 24 similarly includes a through bore 54 that extends through base 52. Bore 54 of frame 24 is aligned with bore 66 of mounting flange 28. Bore 54 is configured to fastener 58 to secure cage 16 to housing 14.

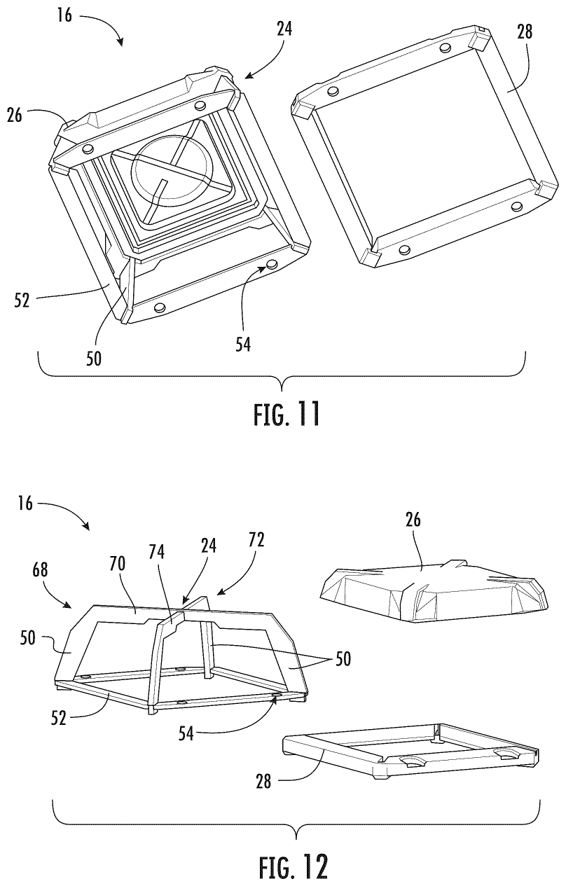

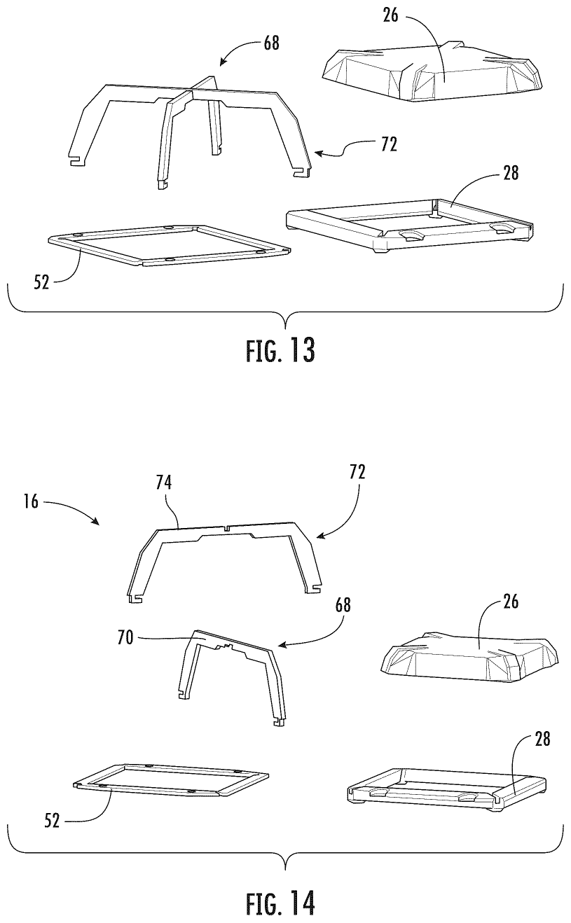

Referring to FIGS. 11-14, partially and entirely exploded views of cage 16 are shown according to an exemplary embodiment. Frame 24 includes a first portion 68 and a second portion 72 that are connectable to base 52. In various specific embodiments, first portion 68 and second portion 72 are arranged to cross each other. in various specific embodiments, first portion 68 is positioned at a generally perpendicular (e.g., 90 degrees plus or minus 10 degrees) from second portion 72. In other words, first portion 68 and second portion 72 form an “X” shape.

First portion 68 of frame 24 includes a first body 70 that extends between and connects opposing legs 50 of first portion 68. In specific embodiments, first body 70 extends in a generally horizontal manner. In other words, first portion 68 has a first leg 50 and a second leg 50 with first body 70 connecting the first leg 50 and second leg 50. Second portion 72 of frame 24 includes a second body 74 that extends between and connects opposing legs 50 of second portion 72. In other words, second portion 72 has a third leg 50 and a fourth leg 50 with second body 74 connecting the third leg 50 and fourth leg 50.

In specific embodiments, second body 74 extends in a generally horizontal manner (e.g., parallel to surface of housing 14). In specific embodiments, legs 50 extend from first body 70 and second body 74 at an angle respectively. In other words, legs 50 do not extend from first body 70 or second body 74 at a perpendicular orientation. In various embodiments, the first leg 50, second leg 50, third leg 50, and fourth leg 50 together define the plurality of windows 22.

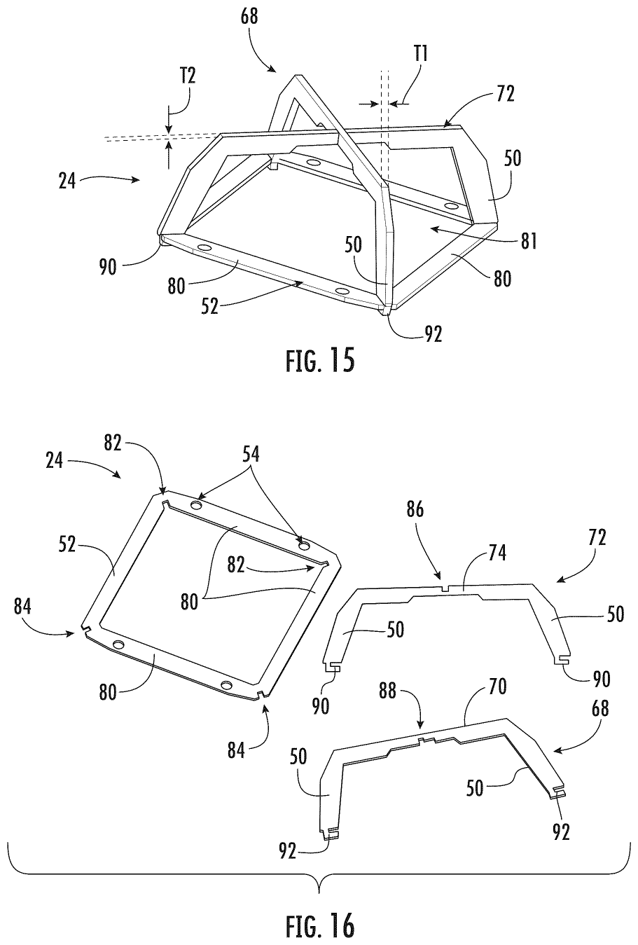

Referring to FIGS. 15-16, details of frame 24 are shown according to an exemplary embodiment. Base 52 of frame 24 includes a plurality of supports 80 configured to engage first portion 68 and second portion 72 of frame 24. In various specific embodiments, base 52 includes four supports 80. In such embodiments, four supports 80 are arranged to form a parallelogram such as a square. In specific embodiments, supports 80 together define a frame opening 81 that has a generally square shape.

As shown in FIG. 15, first portion 68 and second portion 72 each have a thickness, T1 and T2 respectively. In other words, legs 50 each have a thickness defined between opposing side surfaces. In various embodiments, thickness T1 and T2 are the same. In various specific embodiments, thickness T1 and T2 have a uniform thickness.

As previously discussed, Applicant believes frame 24 having a reduced thickness the amount of obstruction of the laser projection (e.g., size of discontinuity). As will be generally understood, typically protective cages have a thickness causing a larger discontinuity in the laser projection. In various specific embodiments, T1 and T2 are less than a maximum thickness.

In various embodiments, frame 24 includes a plurality of engagement portions configured to secure base 52, first portion 68, and/or second portion 72 together. In specific embodiments, frame 24 and specifically base 52 includes engagement portions shown as notches 82, 84. In specific embodiments, notches 82, 82 are positioned at corners of base 52. First portion 68 and second portion 72 of frame each include one or more hooks 90, 92 positioned at a distal end of the leg 50. The one or more hooks 90, 92 are configured to be received within and engage notches 82, 84. In various embodiments, frame 24 further includes additional engagement portions, shown as recesses 86, 88 formed on second body portion 74 and first body portion 70 respectively.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A laser level comprising:
a housing;
a laser generator positioned within the housing and configured to emit a laser projection plane;
a cage rigidly coupled to the housing, the cage comprising:
a frame comprising:
a lower portion;
an aperture in the lower portion of the frame;
a top portion; and
a plurality of legs each extending between the lower portion and the top portion, wherein the plurality of legs together define a plurality of windows;
an upper bumper positioned on the top portion of the frame;
a lower mounting element positioned on the lower portion of the frame, wherein the plurality of windows are positioned between the upper bumper and the lower mounting element;
wherein the frame is formed from a first material and the upper bumper and the lower mounting element are formed a second material, the second material different than the first material; and
wherein the laser generator is configured to direct a laser projection out of the plurality of windows.

2. The laser level of claim 1, wherein the first material is more rigid than the second material.

3. The laser level of claim 1, wherein the first material is metal and the second material is a polymer.

4. The laser level of claim 3, wherein the first material is steel and the second material is nylon.

5. The laser level of claim 1, wherein the frame further comprises a first body that extends between a pair of opposing legs of the plurality of legs and a second body that extends between a second pair of opposing legs of the plurality of legs.

6. The laser level of claim 5, wherein the first body comprises a first recess and the second body comprises a second recess, and wherein the first recess engages the second recess to secure the first body relative to the second body.

7. The laser level of claim 1, wherein the plurality of legs define an exterior surface of the frame.

8. The laser level of claim 1, wherein the cage is positioned on an upward facing surface of the housing, and wherein the laser level further comprises a second cage positioned on a forward facing surface of the housing and a third cage positioned on a side surface of the housing.

9. The laser level of claim 8, wherein the laser generator is configured to emit a second laser projection plane associated with the second cage and a third laser projection plane associated with the third cage.

10. A laser level comprising:
a housing;
a laser generator positioned within the housing and configured to emit a laser projection plane;
a cage fixedly coupled to the housing, the cage comprising:
a frame comprising:
a base comprising an aperture; and
a first portion coupled to the base, the first portion comprising:
a first leg;
a second leg; and
a first body connecting the first leg and the second leg;
a second portion coupled to the base, the second portion comprising:
a third leg;
a fourth leg; and
a second body connecting the third leg and the fourth leg, the second body connected to the first body, wherein the first leg, second leg, third leg, and fourth leg together define a plurality of windows;
an upper bumper positioned on a top of the frame;
a lower mounting element positioned on the base of the frame, wherein the lower mounting element is positioned between the plurality of windows and the base of the frame;
wherein the laser generator is configured to direct a laser projection out of the plurality of windows.

11. The laser level of claim 10, wherein the base further comprises at least two corners, and wherein a notch is defined in each of the at least two corners of the base.

12. The laser level of claim 11, wherein a distal end of the first leg comprises a first hook configured to engage one of the at least two corners of the base and couple the first leg to the base.

13. The laser level of claim 12, wherein a distal end of the second leg comprises a second hook, and wherein the second hook configured to engage the other of the at least two corners of the base and couple the second leg to the base.

14. The laser level of claim 10, wherein the first portion of the frame is positioned in a generally perpendicular orientation relative to the second portion of the frame.

15. The laser level of claim 10, wherein the base further comprises a plurality of through bores, wherein each of the plurality of through bores receives a fastener to couple the base to the housing.

16. The laser level of claim 10, wherein the first body comprises a first recess defined in a lower edge and the second body comprises a second recess defined in an upper edge, and wherein the first recess engages the second recess to secure the first body to the second body.

17. A laser level comprising:
a housing;
a laser generator positioned within the housing and configured to emit a plurality of laser projection planes;
a first cage rigidly coupled to a first surface of the housing, the first cage comprising:
a frame comprising:
a base comprising an aperture; and
a first portion comprising a first leg and a second leg, the first leg and second leg connected to the base;
a second portion comprising a third leg and a fourth leg, the third leg and forth leg connected to the base, wherein the first leg, second leg, third leg, and fourth leg together define a plurality of windows;
an upper bumper positioned on the frame; and
a lower mounting element positioned on the base of the frame, wherein the lower mounting element is positioned between the plurality of windows and the base of the frame;
wherein the laser generator is configured to direct one of the plurality of laser projection planes out of the plurality of windows of the first cage.

18. The laser level of claim 17, further comprising a second cage rigidly coupled to a second surface of the housing, wherein the laser generator is configured to direct one of the plurality of laser projection planes out of a second plurality of windows of the second cage.

19. The laser level of claim 18, further comprising a third cage rigidly coupled to a third surface of the housing, wherein the laser generator is configured to direct one of the plurality of laser projection planes out of a third plurality of windows of the third cage.

20. The laser level of claim 18, wherein the second cage comprises:
a second frame comprising:
a second base; and
a plurality of legs, wherein the plurality of legs together define the second plurality of windows;
a second upper bumper positioned on the second frame; and
a second lower mounting element positioned on the second base, wherein the second lower mounting element is positioned between the second upper bumper and the second surface of the housing.
